(19) United States
(12) Patent Application Publication
(10) Pub. No.: US 2005/0253927 A1
(43) Pub. Date: Nov. 17, 2005

(54) Near infrared illuminated tripwire detector

(76) Inventors: Toomas H. Allik, Alexandria, VA (US); John E. Nettleton, Fairfax Station, VA (US); Kelly Sherbondy, Burke, VA (US); Dalton Dawkins, Landover, MD (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/845,245

(22) Filed: May 14, 2004

(51) Int. Cl. H04N 5/33

(52) U.S. Cl. 348/164

(57) ABSTRACT

A device for distinguishing a tripwire from its natural background comprising a light source for illuminating the tripwire and its natural background with light in the near infrared range; and a camera for photographing the illuminated tripwire and background to obtain a high contrast infrared photographic image thereof. The increased contrast permits the user of the device to detect the tripwire which otherwise could not be detected visually.

### GOVERNMENT INTEREST

The invention described herein may be manufactured, used, sold, imported, and/or licensed by or for the Government of the United States of America.

### BACKGROUND OF THE INVENTION

This invention relates in general to explosives, and more particularly, to mine countermeasures.

The detection of tripwires in the modern battlefield is a challenging problem. A tripwire is a hidden wire that will set off an explosive device such as a mine when tripped on. Tripwires are small diameter wires, about 0.1-1.0 mm in diameter, and several meters in length. They are typically placed at heights of about 20 cm above the ground. They are camouflaged and are extremely difficult to see. In many cases, the initial contact with an enemy is not the mine, but the tripwire that sets off the mine before it can be detected.

In the past, the Army has used a launched grapnel hook to detect and neutralize tripwires. Feeler wires and dogs have also been used. None of these techniques has proved satisfactory.

### SUMMARY OF THE INVENTION

It is therefore an object of this invention to detect a tripwire without setting off the explosive device such as a mine and/or Improvised Explosive Device (IED) before it can be detected.

This and other objects of the invention are achieved in one aspect by a device for distinguishing a tripwire from its natural background comprising means for illuminating the tripwire and its natural background with light in the near infrared range, and means for imaging the illuminated tripwire and background to obtain a high contrast infrared photographic image thereof.

Another aspect of the invention involves a method of distinguishing a tripwire from its natural background comprising the steps of illuminating the tripwire and its natural background with light in the near infrared range, and photographing the illuminated tripwire and background to obtain a high contrast infrared photographic image thereof. The increased contrast permits the user of the device to detect the tripwire which otherwise could not be detected visually.

Additional advantages and features will become apparent as the subject invention becomes better understood by reference to the following detailed description when considered in conjunction with the accompanying drawings wherein:

### BRIEF DESCRIPTION OF THE DRAWINGS

FIG. 1 shows the reflectance spectra of various tripwires and natural backgrounds as recorded with a spectrophotometer.

FIG. 2 is a schematic illustration of a device for distinguishing a tripwire from its natural background in accordance with the invention.

FIG. 3 shows a visible photographic image taken with a CCD camera of four tripwires above a grass camouflage.

FIG. 4 shows an infrared photographic image of the same scene obtained with the inventive device.

### WRITTEN DESCRIPTION OF THE PREFERRED EMBODIMENT

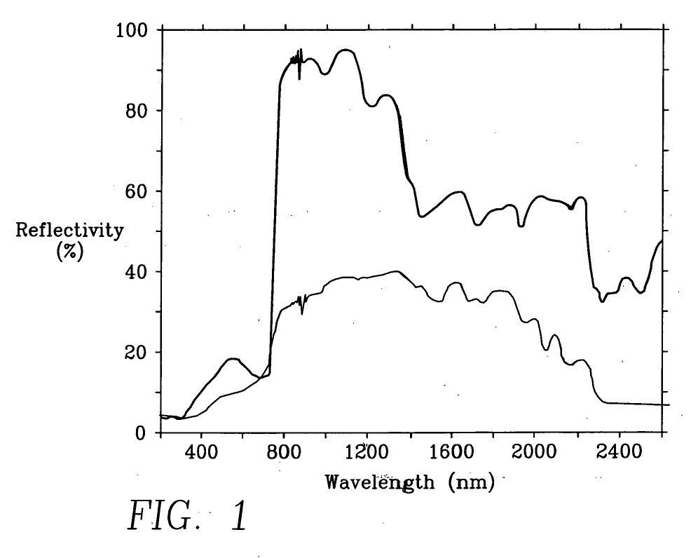

Before entering into the detailed description of one embodiment of the present invention according to the accompanying Figures of the drawing, and referring to FIG. 1, it is helpful to explain the principle of the present invention.

FIG. 1 shows the reflectance spectra of various tripwires and natural backgrounds as recorded with a spectrophotometer. The graph is a plot of reflectivity in percent versus wavelength from 200 nm to 2500 nm. The bold lines represent the reflectivity of the natural background and the thin lines represent the reflectivity of the tripwire.

The lack of contrast between the tripwires and the natural backgrounds for wavelengths in the ultraviolet and visible ranges (less than 700 nm) explains why the tripwires are extremely difficult to see with the eye. However, unexpectedly, wavelengths in the near infrared (wavelengths greater than 700 nm) provide high contrast between the tripwires and the natural backgrounds.

The present invention makes use of this principle to detect the tripwires.

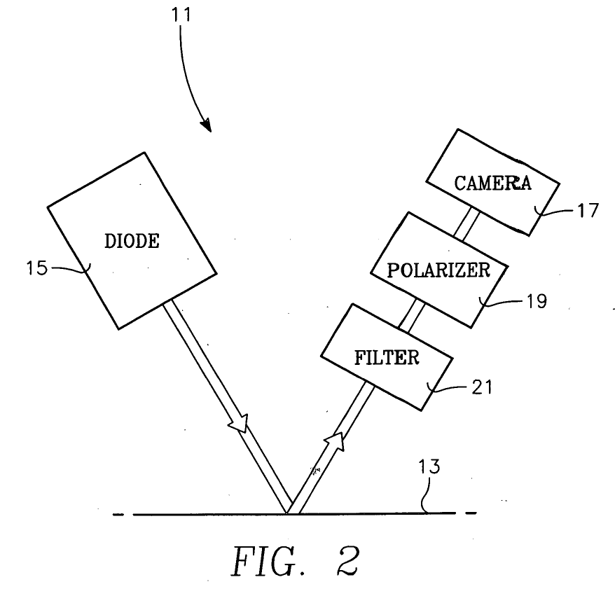

Referring now to FIG. 2, there is shown a block schematic diagram of a device 11 for distinguishing a tripwire 13 from its natural background. The device 11 comprises means for illuminating the tripwire 13 and its natural background with light in the near infrared range, and means for imaging the illuminated tripwire and its natural background to obtain a high contrast infrared photographic image thereof.

While the illuminating means may take a variety of forms, conveniently it may take the form shown of a laser diode 15, such as an Industrial Microphotonics Company (IMC) model LAR56P004W154020A22A laser diode, for example. Diode wavelengths near 1.5 μm (1500 nm) and above are preferred because beams at those wavelengths are more eye-safe, and are transmitted better through the atmosphere. In addition, the beams are barely visible, so operation of the device can be concealed.

While the photographing (imaging) means may take a variety of forms, conveniently it may take the form shown of an Indium Gallium Arsenide (InGaAs) focal plane array infrared camera 17, such as a model Merlin or Phoenix camera manufactured by Indigo Systems Inc. Such cameras 17 are capable of capturing images in the 0.9 μm (900 nm) to 1.7 μm (1700 nm) wavelength band, which encompasses the diode's preferred operating wavelength band of 1.5 μm (1500 nm) and above. Other near infrared cameras, or cameras capable of imaging in the near infrared band (0.7 to 2.0 μm) including near infrared cameras with Indium-Antimony (InSb) or Mercury-Cadmium-Tellurium (HgCdTe) focal plane arrays, would also be function satisfactorily as the photographing means for the present invention.

While the polarizer 19 may take a variety of forms, conveniently it may take the form of a Edmond Scientific company model 54111 near infrared polarizer, placed in front of the camera. The optical filter 21 is preferably a CVI Laser company model 1.54 μm interference filter, placed in front of the camera.

In operation, the polarized laser diode 15 illuminates the tripwire and its natural isotropic background with light in the near infrared range, and the infrared camera 17 captures a high contrast infrared photographic image of the scene. The polarizer 19 and the optical filter 21 further increase the contrast and reduce the solar background. The increased contrast permits the user of the device to detect the tripwire which otherwise could not be detected visually.

### Test Results

The results of actual tests of an embodiment of the invention are presented below.

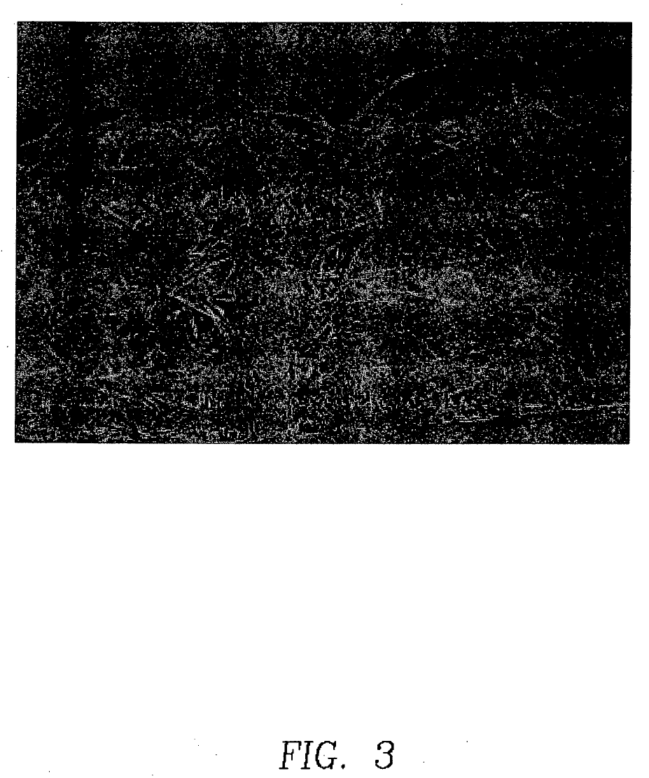

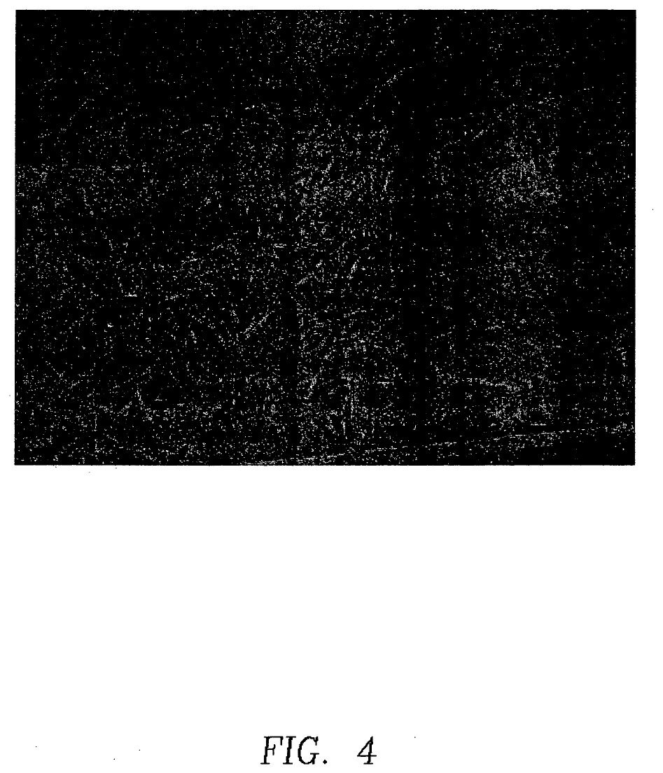

FIG. 3 shows a visible photographic image taken with a CCD camera of four tripwires above a grass camouflage. Only two tripwires 13 are barely visible. FIG. 4 shows an infrared photographic image of the same scene obtained with the inventive device. Note that in FIG. 4, all four tripwires are visible. In FIG. 4, the polarizer was set at 0 degrees. It is to be understood, however, that the polarizer can be at other settings, such as 30, 60 or 90 degrees, for example, to maximize the contrast between the tripwires and the surrounding background.

It is obvious that many modifications and variations of the present invention are possible in light of the above teachings. It is therefore to be understood that within the scope of the appended claims, the invention may be practiced otherwise than as described.

1. A device for distinguishing a tripwire from its natural background comprising:
means for illuminating the tripwire and its natural background with light in the near infrared range;
means for photographing the illuminated tripwire and background to obtain a high contrast infrared photographic image thereof; and,
the increased contrast permitting the user of the device to detect the tripwire which otherwise could not be detected visually.

2. The device recited in claim 1 wherein the illuminating means is selected from the group consisting of laser diodes, light emitting diodes or filtered lamps.

3. The device recited in claim 2 wherein the wavelength of the laser diode is at least 1.5 μm.

4. The device recited in claim 1 wherein the photographing means includes a near infrared camera.

5. The device recited in claim 4 wherein the camera is capable of capturing an image in the near infrared (0.7-2.0 μm) wavelength band.

6. The device recited in claim 4 wherein said camera includes a focal plane array made of materials selected from the group of Indium-Gallium-Arsenide (InGaAs), Indium-Antimony (InSb) and Mercury-Cadmium-Tellurium (HgCdTe).

7. The device recited in claim 4 wherein the photographing means includes a polarizer placed in front of the camera for increased contrast and reduction of solar background.

8. The device recited in claim 7 wherein the polarizer is set at angle between 0 degrees and 90 degrees.

9. The device recited in claim 4 wherein the photographing means includes an optical filter placed in front of the camera for increased contrast and reduction of solar background.

10. The device recited in claim 1 in combination with the tripwire.

11. A device for distinguishing a tripwire from its natural background, comprising:
a laser diode for illuminating the tripwire and its natural background with light in the near infrared range;
an near infrared focal plane array camera spaced from the diode for photographing the illuminated tripwire and its natural background to obtain a high contrast infrared photographic image thereof;
a polarizer placed in front of the camera for increased polarized contrast; and,
an optical filter placed in front of the camera for increased contrast and reduction of solar background.

12. The device recited in claim 11 in combination with the tripwire.

13. A method of distinguishing a tripwire from its natural background comprising the steps of:
illuminating the tripwire and its natural background with light in the near infrared range; and,
photographing the illuminated tripwire and background to obtain a high contrast infrared photographic image thereof,
the increased contrast permitting detection of the tripwire which otherwise could not be detected visually.

14. The method recited in claim 13 wherein the illuminating step includes:
lasing with a laser diode.

15. The method recited in claim 13 wherein the illuminating step is accomplished with a light emitting diode (LED).

16. The method recited in claim 13 wherein the illuminating step is accomplished with a filtered lamp.

17. The method recited in claim 13 wherein the photographing step includes:
capturing an image in the near infrared wavelength band.

18. The method recited in claim 13 wherein the photographing step includes:
viewing a polarized component of the light reflected from the illuminated tripwire and its background.

19. The method recited in claim 13 wherein the photographing step includes:
optically filtering the light reflected from the illuminated tripwire and its background.
